(19) United States
(12) Patent Application Publication
(10) Pub. No.: US 2014/0311383 A1
(43) Pub. Date: Oct. 23, 2014

(54) STRUCTURAL THREE DIMENSIONAL NANOCOMPOSITE WITH SPHERICAL SHAPED NANOPARTICLES IN A NANO METAL MATRIX OR A POLYMER MATRIX

(71) Applicant: VIT University (Vellore Institute of Technology), Vellore (IN)

(72) Inventor: Thirunavukkarasu Asaimuthu, Chennai (IN)

(21) Appl. No.: 14/254,119

(22) Filed: Apr. 16, 2014

Related U.S. Application Data
(60) Provisional application No. 61/812,723, filed on Apr. 17, 2013.

(51) Int. Cl. C08K 3/36; C08K 3/14; C08K 3/08; C08K 3/34; C08K 3/22; C08K 3/26

(52) U.S. Cl. CPC C08K 3/36; C08K 3/22; C08K 3/26; C08K 3/08; C08K 3/34; C08K 3/14; C08K 2003/2227; C08K 2003/265; C08K 2003/0812
USPC 106/286.2; 524/557; 524/567; 524/577; 524/430; 524/427; 524/425; 524/437; 521/141; 521/146; 521/145; 521/158; 524/590; 106/286.5; 106/286.1; 106/286.4; 106/286.6; 106/286.3

(57) ABSTRACT

A structural three dimensional nanocomposite with improved mechanical properties is provided. The structural three dimensional nanocomposite includes (a) spherical shaped nanoparticles, (b) a matrix, and (c) an inter phase structure. The matrix may be selected from at least one of (a) polymer matrix, and (b) a nano metal matrix. The spherical shaped nanoparticles are reinforced with the matrix. The spherical shaped nanoparticles are uniformly distributed throughout the matrix. The inter phase structure transfers stress from the matrix to obtain the spherical shaped nanoparticles with improved mechanical properties. The structural three dimensional nanocomposite have high and equal mechanical strength in three dimensions when the structural three dimensional nanocomposite is at least one of (a) volume compressive stress condition, and (b) volume expansive stress condition.

### BACKGROUND

1. Technical Field

The embodiments herein generally relate to nanocomposites, and, more particularly, to optimize mechanical properties of a structural three dimensional nanocomposite by reinforcing spherical shaped nanoparticles in a nano metal matrix or a polymer matrix.

2. Description of the Related Art

Nanocomposite materials have been used in mechanical enhancing and stabilizing materials such as a nano metal, a polymer, and a semiconductor. The nanocomposite materials have superior mechanical properties over microcomposite materials. Nanoparticles in the nano metal, and the polymer matrix provides the mechanical properties to the nanocomposite materials. Higher levels of nanoparticles added to the polymer to increase the desired property. Sometimes, a less amount of the nanoparticles added to the polymer to change the desired property to a detriment property. Also, the mechanical properties of the nanocomposite materials are depending on the dimensions of the nanocomposite materials. For example, in nonwoven webs containing nanoparticles in the nanocomposite is based on the nanoparticles in the polymer matrices. In another example, a high yield strength outer casing for integrity of a wall of an electric cell is based on the nanoparticles in metal matrices. These innovations showed some actualization of the mechanical properties of the nanocomposite materials. But, above mentioned two approaches are not optimal and not rigorous. Hence, the mechanical properties of the nanocomposite materials are much average.

Accordingly, there remains a need for optimizing mechanical properties of a structural three dimensional nanocomposite.

### SUMMARY

In view of a foregoing, an embodiment herein provides a structural three dimensional nanocomposite composition with improved mechanical properties. The structural three dimensional nanocomposite composition includes (a) spherical shaped nanoparticles, (b) a matrix, and (c) an inter phase. The spherical shaped nanoparticles are reinforced with the matrix. The spherical shaped nanoparticles are uniformly distributed throughout the matrix. The inter phase transfers stress from the matrix to the spherical shaped nanoparticles to obtain the structural three dimensional nanocomposite composition with improved mechanical properties.

The metal matrix may be selected from at least one of (a) a nano metal matrix, and (b) a polymer matrix. The nano metal matrix may be (a) an aluminum, (b) a magnesium, (c) stainless steel, and (d) a titanium. The polymer matrix may be (a) a poly vinyl alcohol, (b) a poly vinyl chloride, and (c) a polystyrene. The spherical shaped nanoparticles may be added with nano clay particles to decrease permeability of gases in packaging polymer applications.

In one aspect, a process of preparation of a structural three dimensional nanocomposite with improved mechanical properties is provided. The process includes the following steps of: (a) providing spherical shaped nanoparticles, and (b) providing a matrix. In one embodiment, the matrix is a polymer matrix. The process further includes the steps of: (c) providing an inter phase structure that transfers the polymer matrix to the spherical shaped nanoparticles, and (d) reinforcing the spherical shaped nanoparticles with the polymer matrix to obtain the structural three dimensional nanocomposite with improved mechanical properties. The matrix may be a nano metal matrix, in one embodiment. The nano metal matrix may be (a) an aluminum, (b) a magnesium, and (c) a titanium. The polymer matrix may be (a) a poly vinyl alcohol, (b) a poly vinyl chloride, and (c) a polystyrene. The spherical shaped nanoparticles may be added with nano clay particles to decrease permeability of gases in packaging polymer applications.

In yet another aspect, a structural three dimensional nanocomposite with improved mechanical properties is provided. The structural three dimensional nanocomposite includes (a) spherical shaped nanoparticles, (b) a matrix, and (c) an inter phase structure. The matrix may be selected from at least one of (a) polymer matrix, and (b) a nano metal matrix. The spherical shaped nanoparticles are reinforced with the matrix. The spherical shaped nanoparticles are uniformly distributed throughout the matrix. The inter phase structure transfers stress from the matrix to obtain the spherical shaped nanoparticles with improved mechanical properties. The structural three dimensional nanocomposite have high and equal mechanical strength in three dimensions when the structural three dimensional nanocomposite is at least one of (a) volume compressive stress condition, and (b) volume expansive stress condition.

In one embodiment, the mechanical properties include at least one of measurement of (a) elasticity, (b) tensile strength, (c) fracture toughness, and (d) fracture energy. In another embodiment, the mechanical strength of the structural three dimensional nanocomposite is high when 5% of the spherical shaped nanoparticles are added with the matrix.

In yet another embodiment, the structural three dimensional nanocomposite is light weight material due to improved mechanical strength and modulus. The structural three dimensional nanocomposite may be suitable for applications at a higher temperature.

In yet another embodiment, the mechanical properties are determined based on a size of spherical shaped nanoparticles reinforcement, a inter phase size structure, a strength of the spherical shaped nanoparticles, and a strength of the inter phase structure. The mechanical strength may be increased when mechanical strength of the matrix is increased due to size of 15 nm of the matrix. The structural three dimensional nanocomposite may be suitable for aerospace products and sport products due to less complexity and better affordability. The structural three dimensional nanocomposite may be transparent to light due to high mechanical properties of the nanocomposite.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 is a table view that illustrates a calculation of surface area to volume ratio at different size and shape of nanoparticles according to an embodiment herein;

FIG. 2 is a table view that illustrates a calculation of stress of the nanoparticles based on changes in angle according to an embodiment herein;

FIG. 3 is a graphical representation that illustrates a strengthening in micron size particles reinforcements and nanosize particles reinforcements according to an embodiment herein;

FIG. 4 is a graphical representation that illustrates a computed Young's modulus of an unidirectional nanocomposite of different aspect ratios according to an embodiment herein;

FIG. 5 is a graphical representation that illustrates a maximum strength in micron size particles reinforcements and nanosize particles reinforcements according to an embodiment herein; and

FIG. 6 is a graphical representation that illustrates a quantitative extent of strengthening with addition of spherical nanosize particles reinforcements according to an embodiment herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

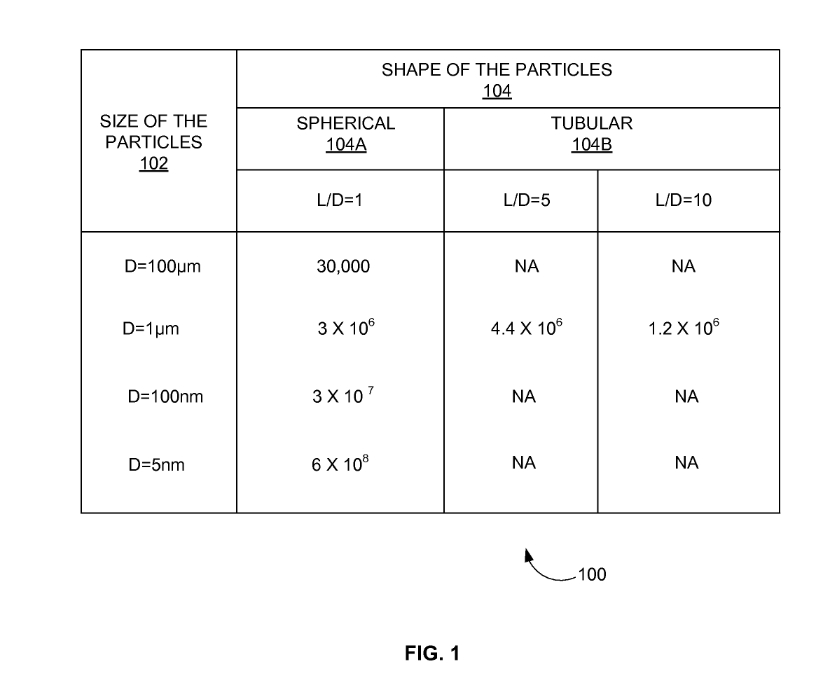

As mentioned, there remains a need for optimizing mechanical properties of a structural three dimensional nanocomposite. The embodiments herein achieve this by providing a structural three dimensional nanocomposite with improved mechanical strength. The structural three dimensional nanocomposite includes (a) spherical shaped nanoparticles, (b) a matrix, and (c) an inter phase. The spherical shaped nanoparticles are reinforced with the matrix. The spherical shaped nanoparticles are uniformly distributed throughout the matrix. The inter phase transfers stress from the matrix to the spherical shaped nanoparticles to obtain the structural three dimensional nanocomposite composition with improved mechanical properties. The structural three dimensional nanocomposite have high and equal mechanical properties all three dimensions when the structural three dimensional nanocomposite is in volume compressive condition, and volume expansive stresses condition. Referring now to the drawings, and more particularly to FIGS. 1 through 6, where similar reference characters denote corresponding features consistently throughout the figures, there are shown preferred embodiments.

The structural three dimensional nanocomposite with spherical shaped nanoparticles in nano metal and polymer matrices provide high and equal mechanical properties in all dimensions when the structural three dimensional nanocomposite is in volume compressive stress condition, and/or volume expansive stress condition. The high and equal mechanical properties in all dimensions may be proved by calculating a negative Poisson ratio value. The nano metal matrix or the polymer matrix material may transfers stress to the spherical shaped nanoparticles reinforcement through a inter phase structure. The nano particle may have high surface area to volume ratio. Hence, the nano metal matrix or the polymer matrix material has very high surface area of nanoparticles to transfer a large amount of stress to the spherical shaped nanoparticles reinforcement. A cross section and a length of the nanoparticles are greater than a critical length in one direction or all directions at a same time. Hence, the nano metal matrix or the polymer matrix material may transfer a large stress to the nanoparticles in all dimensions when the structural three dimensional nanocomposite is in volume compressive stress condition, and/or volume expansive stress condition.

The metal matrix or polymer matrix is varying with a size of the spherical shaped nanoparticles reinforcement and flexibility. The size of the metal matrix or polymer matrix is comparable to the size of the spherical shaped nanoparticles reinforcement. Hence, the strength of the inter phase structure is formed which transfers load between the metal matrix or polymer matrix and the spherical shaped nanoparticles to obtain the nanocomposite with improved mechanical strength. The size of the matrix nanostructure (i.e. grain size) and the spherical shaped nanoparticles size of reinforcement ensure a mechanical locking and a mechanical integration of the matrix nanostructure. The nanosize of the metal matrix or the polymer matrix, and the spherical shaped nanoparticles reinforcement size may vary based on the required mechanical properties. The mechanical property is increased in the metal matrix due to the size of the nano grain (e.g., 15 nm) in the metal matrix.

The strong inter phase structure mechanically locks the spherical shaped nanoparticles and the nano structured metal matrix or the polymer matrix. Hence, the load transfers between the nano metal matrix or the polymer matrix and the spherical shaped nanoparticles even though the nanoparticles may have an elastic modulus as much as 100 times of the polymer matrix and 10 times of the metal matrix. The structural three dimensional nanocomposite with the spherical shaped nanoparticles have strength in all dimensions in the nano metal matrix or the polymer matrix at well-spaced intervals. The structure of the nanocomposite is also strength in all directions equally. The strength of the structured nanocomposites is four and/or five times high of matrix microscopic equivalent metal matrix or polymer matrix. The spherical shaped nanoparticles may be used as a rhombus shaped, and a square shaped. The combination of microscopic size grains and nano size grains in the metal matrix or the polymer matrix provide high mechanical properties of the structural three dimensional nanocomposite. An alloy matrix is treated with high temperature and time to produce precipitates of the nano size. The nano size matrix is produced high mechanical strength in the structural three dimensional nanocomposite.

FIG. 1 is a table view 100 that illustrates a calculation of surface area to volume ratio at different size and shape of nanoparticles according to an embodiment herein. The table view 100 includes a size of particles field 102, and a shape of the particles field 104. The shape of the particles field 104 further includes spherical shape particles 104A and tubular shape particles 104B. The surface area to the volume ratio of the spherical shape particles 104A is high. For example, the surface area to the volume ratio of the spherical shape particles 104A is 30,000 when a diameter is 100 μm and a length to diameter (L/D) is 1. The surface area to the volume ratio of the spherical shape particles 104A is 3×10⁶ when the diameter is 1 μm and the length to diameter (L/D) is 1. The surface area to the volume ratio for the spherical shape particles 104A is 3×10⁷ when the diameter is 100 nm and the length to diameter (L/D) is 1. The surface area to the volume ratio for the spherical shape particles 104A is 6×10⁸ when the diameter is 5 nm and the length to diameter (L/D) is 1.

Similarly, a surface area to the volume ratio of the tubular shape particles 104B is 4.4×10⁶ when the diameter is 1 μm and the length to diameter (L/D) is 5. The surface area to the volume ratio for the tubular shape particles 104B is 1.2×10⁶ when the diameter is 1 μm and the length to diameter (L/D) is 10. In one embodiment, the surface area to the volume ratio of the tubular shape particles 104B is not applicable when (a) the diameter is 100 μm and the length to diameter (L/D) is 5, (b) the diameter is 100 nm and the length to diameter (L/D) is 5, and (c) the diameter is 5 nm and the length to diameter (L/D) is 5. In another embodiment, the surface area to the volume ratio of the tubular shape particles 104B is not applicable when (a) the diameter is 100 μm and the length to diameter (L/D) is 10, (b) the diameter is 100 nm and the length to diameter (L/D) is 10, and (c) the diameter is 5 nm and the length to diameter (L/D) is 10. In one embodiment, a process of preparation of the structural three dimensional nanocomposite with improved mechanical strength is obtained. The spherical shaped nanoparticles used in the three dimensional composite may be of similar size or different sizes. Similarly, two or more composition of spherical shaped nanoparticles may be used in the structural three dimensional nanocomposite. For example, (a) silver nanoparticles are used for anti-microbial properties, (b) ceramic nanoparticles are used for strengthening. The composition may include a metal, compound materials, minerals, ceramic nanoparticles. The structural three dimensional nanocomposite may be facilitated with improved mechanical properties when a size of the spherical shaped nanoparticles is around 100 nm.

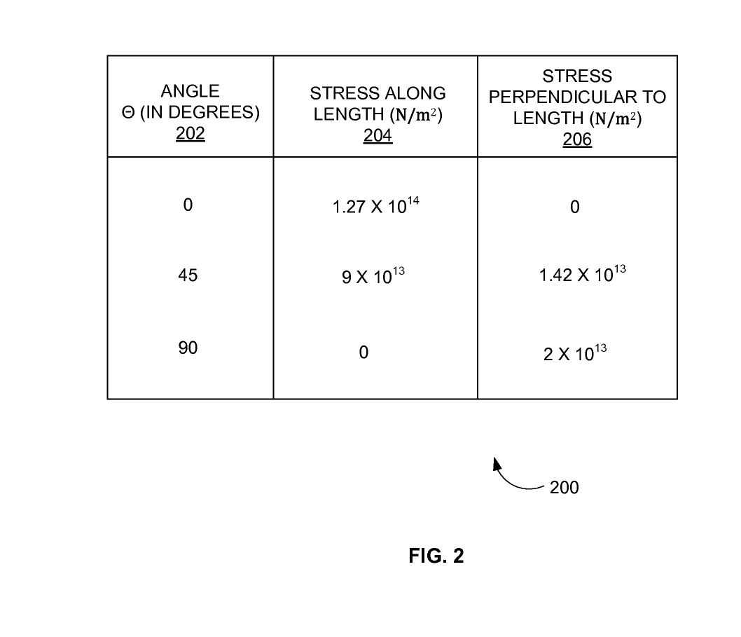

FIG. 2 is a table view 200 that illustrates a calculation of stress of the nanoparticles based on changes in angle according to an embodiment herein. The table view 200 includes an angle field 202, a stress along length field 204, and a stress perpendicular to the length field 206. The stress along the length of the nanoparticles and the stress perpendicular to the length of the nanoparticles are calculated based on different angles of the nanoparticles. For example, the stress along the length of the nanoparticles is 1.27×10¹⁴ N/m² when the angle associated with the nanoparticles is 0 degree. The stress perpendicular to the length of the nanoparticles is 0 N/m² when the angle associated with the nanoparticles is 0 degree. Similarly, the stress along the length of the nanoparticles is 9×10¹³ N/m² when the angle associated with the nanoparticles is 45 degree. The stress perpendicular to the length of the nanoparticles is 1.42×10¹³ N/m² when the angle associated with the nanoparticles is 45 degree. Similarly, the stress along the length of the nanoparticles is 0 N/m² when the angle associated with the nanoparticles is 90 degree. The stress perpendicular to the length of the nanoparticles is 2×10¹³ N/m² when the angle associated with the nanoparticles is 90 degree. In one embodiment, the nanoparticles may be a spherical shape. In one embodiment, the stress along the length of the nanoparticles and the stress perpendicular to the length of the nanoparticles may be calculated for the diameter (i.e. D=100 nm) and the length to diameter (L/D) (e.g., L/D=5) of the nanoparticles.

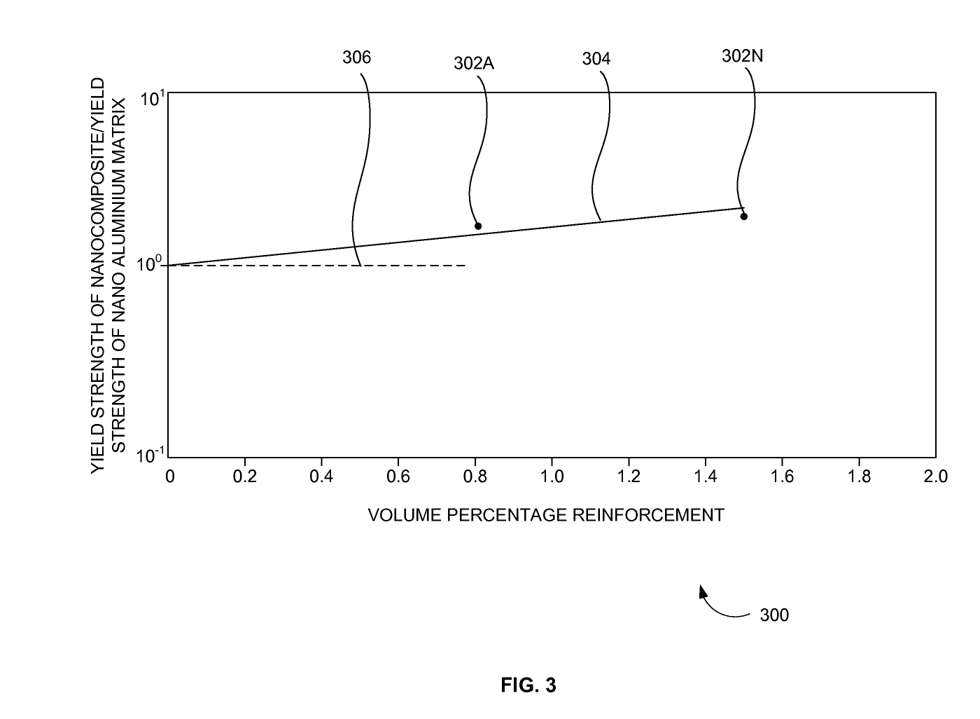

FIG. 3 is a graphical representation 300 that illustrates a strengthening in micron size particles reinforcements and nanosize particles reinforcements according to an embodiment herein. The graphical representation 300 includes nanocomposite data 302 A-N, an exponential curve fit of the nanocomposite data 304 and micron size composite 306. For example, a volume percentage reinforcement of the nanocomposite is represented in X-axis. Similarly, yield strength of the nanocomposite/yield strength of nano aluminum matrix are represented in Y-axis. The exponential curve fit of the nanocomposite data 304 is drawn through the nanocomposite data 302 A-N that shows the strengthening in the nanocomposite. In one embodiment, the micron size composite 306 have less strength than the nanocomposite. In one embodiment, the nanocomposite data 302A-N (e.g., dot points in FIG. 3) is calculated by adding the nanoparticles to the nanocomposite. The line is showing the exponential curve fit of nanocomposite data.

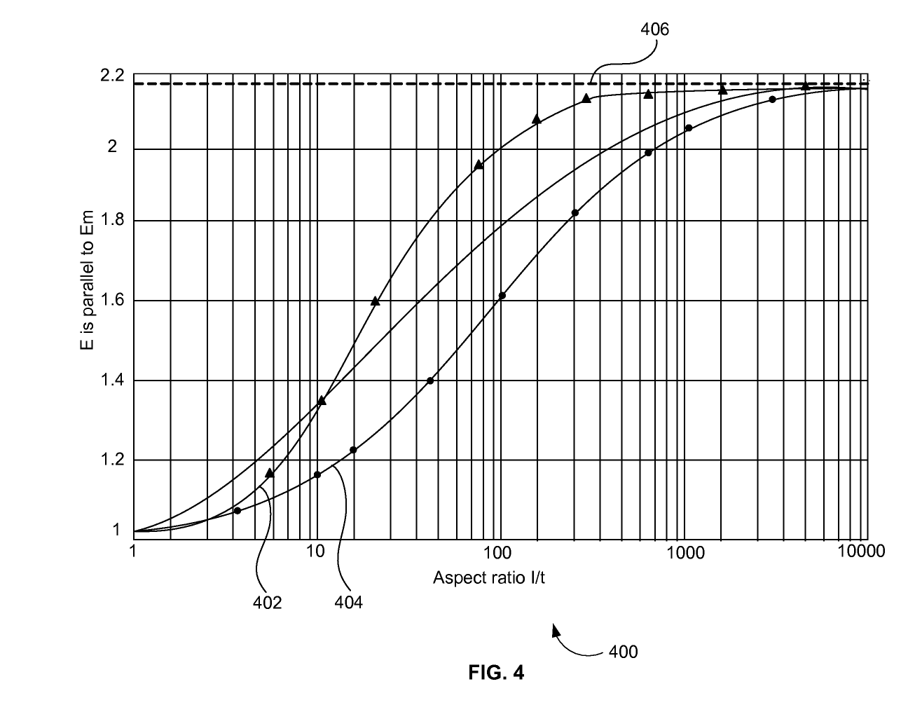

FIG. 4 is a graphical representation 400 that illustrates a computed Young's modulus of a unidirectional nanocomposite of different aspect ratios according to an embodiment herein. The graphical representation 400 includes a curve fit of the computed Young's modulus of the unidirectional composite filled with fiber 402, and a curve fit of the computed Young's modulus of the unidirectional composite filled with flake 404 and a rule of mixtures 406. For example, the aspect ratio (l/t) is represented in X-axis. Similarly, the calculation of Young's modulus (i.e. E is parallel to Em) is represented in Y-axis. The Young's modulus of the unidirectional composite filled with fiber is stronger reinforcement. The aspect ratio of the fiber may be (0.5 l/t)^{1.8}. The aspect ratio of the flake may be (2/3) Ft. In one embodiment, the Young's modulus of the unidirectional composite filled with fiber may be stronger than platelets. In one embodiment, Poisson ratio value is calculated. In one embodiment, the rule of mixtures 406 is a linear dependence of volume percentage of a fraction and elastic modulus (i.e. the young's modulus) of (a) the fiber, and (b) the matrix. The calculation of the young's modulus of the fiber is E_{L}=ErVr+EmVm. In another embodiment, (a) Er is a young's modulus of the fiber reinforcement, (b) Vr is a volume percentage of the fiber reinforcement, (c) Em is a young's modulus of the matrix, and (d) Vm is a volume percentage of the matrix.

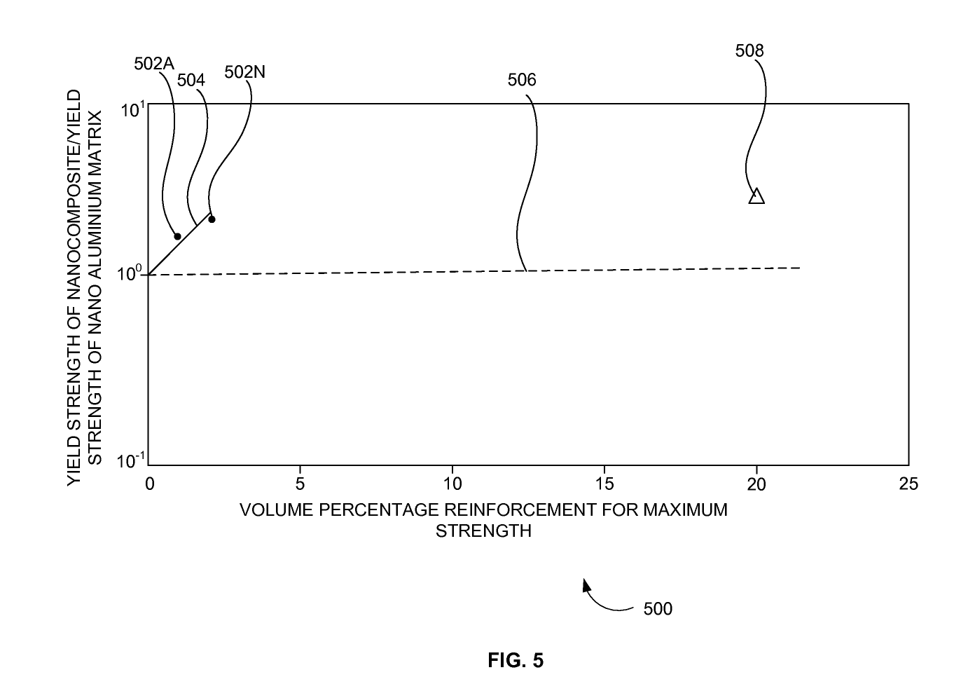

FIG. 5 is a graphical representation 500 that illustrates a maximum strength in micron size particles reinforcements and nanosize particles reinforcements according to an embodiment herein. The graphical representation 500 includes nanocomposite data 502 A-N, an exponential curve fit of the nanocomposite data 504, micron size composite 506, and submicron composite 508. For example, a volume percentage reinforcement of the nanocomposite is represented in X-axis. Similarly, yield strength of the nanocomposite/yield strength of the nano aluminum matrix is represented in Y-axis. The exponential curve fit of the nanocomposite 504 is drawn through the nanocomposite data 502 A-N that shows high strengthening in the nanocomposite. In one embodiment, the strengthening of the nanocomposite is higher than the micron size composite 506 and the submicron composite 508. In one embodiment, strength of a material is high when nanoparticles added up to 5% that provides high mechanical strength to the material.

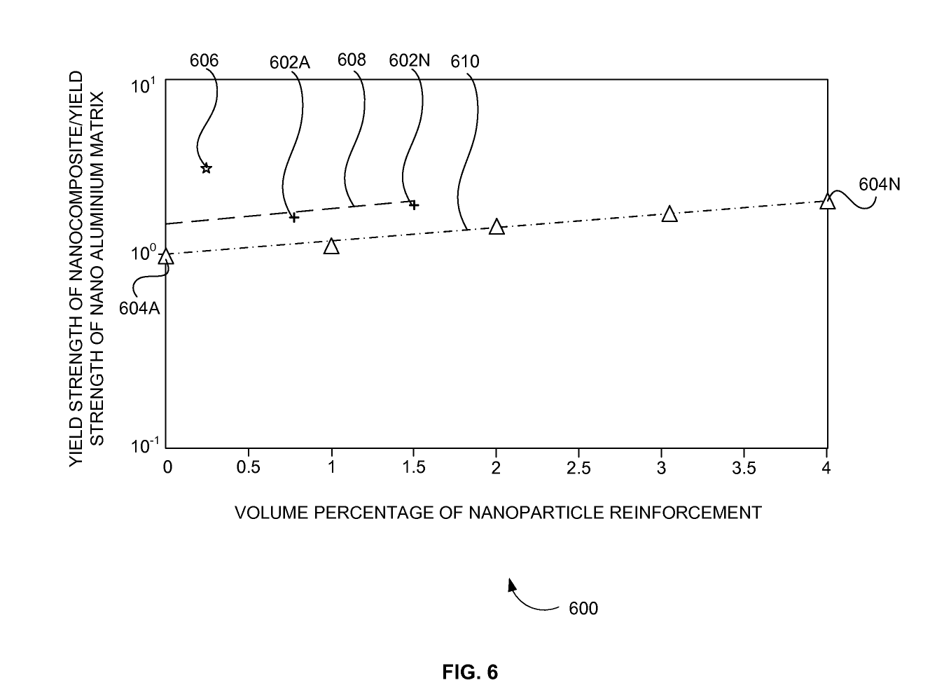

FIG. 6 is a graphical representation 600 that illustrates a quantitative extent of strengthening with addition of spherical nanosize particles reinforcements according to an embodiment herein. The graphical representation 600 includes nanocomposite data 602 A-N, a theoretical calculation of pure aluminum matrix nanocomposite 604 A-N, commercial pure aluminum nanocomposite published data 606, an exponential curve fit of an aluminum 6063 nanocomposite 608, and an exponential curve fit with theoretical calculation of the commercial pure aluminum nanocomposite 610. A volume percentage reinforcement of the nanocomposite is represented in X-axis. Yield strength of the nanocomposite/yield strength of the nano aluminum matrix is represented in Y-axis. The quantitative extend of strengthening of (a) the aluminum 6063 (e.g., Al 6063) nanocomposite data 602 A-N, and (b) the commercial pure aluminum matrix nanocomposite 604 A-N is high when the spherical nanosize particles are added in the nanocomposite. In one embodiment, the exponential curve fit of the aluminum 6063 nanocomposite 608 is drawn through the aluminum 6063 (i.e. Al 6063) nanocomposite data 602 A-N. In another embodiment, the exponential curve fit with the theoretical calculation of the commercial pure aluminum nanocomposite 610 is drawn through the theoretical calculation of pure aluminum matrix nanocomposite 604 A-N. For example, the theoretical calculation of the aluminum AL 6063 is

$$\frac{{σ}_{ys , nanocomposites}}{{σ}_{ys , nano Al matrix}} = ( 1.0426 ) \times {( 1.6151 )}^{( volume percent nano {Al}_{2} {O}_{3} )} .$$

The theoretical calculation of the commercially pure aluminum matrix nanocomposite is

$$\frac{{σ}_{ys , nanocomposites}}{{σ}_{ys , nano Al matrix}} = ( 0.9705 ) \times {( 1.2249 )}^{( volume percent nano {Al}_{2} {O}_{3} )} .$$

In an example embodiment, a table that includes applications with high mechanical property in the structural three dimensional nanocomposite with spherical shaped nanoparticles in the nano metal matrix or the polymer matrix materials.

| | Spherical shaped nanoparticles in a nano |
|---|---|
| Applications | metal matrix or in a polymer matrix |
| Electrical cell | Al2O3 nano/Al nano matrix |
| Electronics Packaging | (i) Ceramic nano particle, Al2O3 etc. (ii) |
| | nano ceramic Al2O3 etc/in nano aluminum |
| Body side moulding | Al2O3 nano/in polymer |
| Cargo bed | Al2O3/in polymer |
| Transportation vehicles | SiC or SiO₂/in nanocomposite foams |
| Sanding coatings | TiO2 and (Fe₂O₃ + ZnO) in polymer |
| Abrasion coatings | ZnO& TiO₂ in polymer |
| Anti reflection coatings | SiO₂, TiO₂ in aluminum |
| Colour change with change in perspective on | SiO₂, TiO₂ in aluminum |
| car surface | |
| Scratch resistant varnish | SiO₂, TiO₂ in aluminum |
| Engine cover | SiO₂, TiO₂ in aluminum |
| Inverter cover | SiO₂, TiO₂ in aluminum |
| Timing belt cover | SiO₂, TiO₂ in aluminum |
| Polymeric foam | TiO₂ in PUF |
| Truck drive shafts | Al₂O₃/in Aluminum |
| Brake rotors | Al2O3/in Aluminum |
| Brake drums | Al2O3/in Aluminum |
| Diesel Engine pistons | Al2O3/in Aluminum |
| Engine components | Al2O3 in TiAl |
| Diesel particulate filters | Al2O3/TiAl |
| Spray Coatings | Al2O3 in TiAl |
| Brake System components | Al2O3, SiC in Al or Mg |
| Intake & Exhaust valves | Al2O3, SiC in Al or Mg |
| Piston liners | Al2O3, SiC in Al or Mg |
| Body Panels | Al2O3 in polymer |
| Instrument panels | Al2O3 in polymer |
| Side moldings | Al2O3 in polymer |
| Trim | Al₂O₃ in polymer |
| Panels | Al2O3 in polymer |
| Bumper | Nano particle/polymer |
| | CaCO3/Eco flex |
| Farclas | Al2O3 in polymer |
| Fuel liners | Al2O3 in polymer |
| Crash worthy Transportation | Al2O3 in polymer |
| Vehicle Structures | Al2O3 in polymer |
| Protective armor | Al2O3 in polymer |
| Noise & Vibration control | Al2O3 in polymer |
| Fracture-resistant structure | Al2O3 in polymer |
| Gas tanks | CaCO3/Eco flex |
| Interior & Exterior panels | CaCO3/Eco flex |
| Diapers | Al (or) Al2O3 (or) CaCO3 in polymer |
| Incontinence briefs | Al (or) Al2O3 (or) CaCO3 in polymer |
| Feminine hygiene garments | Al (or) Al2O3 (or) CaCO3 in polymer |
| Wipes such as facial cleaning cloth | Al (or) Al2O3 (or) CaCO3 in polymer |
| Body & personal cleansing | Al (or) Al2O3 (or) CaCO3 in polymer |
| Clothes and/or hand mitts | Al (or) Al2O3 (or) CaCO3 in polymer |
| Beauty & cleansing applications | Al (or) Al2O3 (or) CaCO3 in polymer |
| Polishing cloth | Al (or) Al2O3 (or) CaCO3 in polymer |
| Floor cleaning wipes | Al (or) Al2O3 (or) CaCO3 in polymer |
| Furniture linings | Al (or) Al2O3 (or) CaCO3 in polymer |
| Durable garments | Al (or) Al2O3 (or) CaCO3 in polymer |
| Badminton racket | SiO₂ in polymer |
| Baseball bat | Al2O3 in polymer |
| Bicycle frame | Al2O3 in polymer |
| Bowling ball | Al2O3 in polymer |
| Crampon | Al2O3 in polymer |
| Fishing rods & poles | Nanoparticles or Al2O3 or Ti/in polymer |
| Golf ball | Al2O3 in polymer |
| Golf shaft | Al2O3 in polymer |
| Hockey sticks | Al2O3 in polymer |
| Ski | SiO₂in polymer |
| Snow board | Al2O3 in polymer |
| Tennis ball | Al2O3 in polymer |
| Tennis Racket | Al2O3 in Aluminum |
| Golf Clubs | Al2O3 in Aluminum |
| Bicycle components | Al2O3 in Aluminum |
| Sports bikes | Al2O3 in Aluminum |
| Sandwich structures | SiC or SiO₂ in polymer foam |
| Airframe | SiC or SiO₂ in polymer foam |
| Space structures | SiC or SiO₂ in polymer foam |
| Sandwich foams | TiO₂ in PUF |
| Airframe | Al2O3, CaCO3, SiC, SiO₂ in polymer |
| Gas Turbine Engine wear parts | Al2O3, CaCO3, SiC, SiO₂ in polymer |
| Vertical fins | Al2O3 etc. in Al or Mg |
| Fan exit guide vanes in jet engine | Al2O3 etc. in Al or Mg |
| Sikorsky S92 & Euro copter transmission | Al2O3 in Mg |
| casing | |
| Flame retardant panels | CaCO3 in Eco flex |
| High performance components | CaCO3 in Eco flex |
| Space vehicle structural parts | CaCO3 in Eco flex |
| Sandwich structures | SiC or SiO₂ in foams |
| Armor | SiC in Ti |
| Military vehicles | SiC in Ti |
| Missile structures | SiC in Ti |
| Power train parts | SiC in Ti |
| Light weight aircraft engine parts | SiC in Ti |
| Ground vehicles | SiC in Ti |
| Ballistic Armor | SiC in Ti |
| F-16 Aircraft ventral fins | Al2O3 in Al |
| F-16 Aircraft fuel access covers | Al2O3 in Al |
| Light weight military vehicles | MgO in Mg |
| Armor systems | MgO in Mg |
| Fuel efficient ground vehicle | Al2O3 in Mg |
| Vehicle Demonstrator engine blocks | |
| Fuel efficient ground | Al2O3 in Mg |
| Vehicle Demonstrator-engine housings | |
| Tactical wheeled vehicles-gear housings | Al2O3 in Mg |
| Sikorsky Black Hawk transmission | Al2O3 in Mg |
| Sikorsky Black Hawk gear housing | Al2O3 in Mg |
| Light weight Armor | Al2O3 in Mg |
| Personal helmet design | Al2O3 in Mg |
| Personal body armor | Al2O3 in Mg |
| Fighter aircraft parts | Al2O3 in Al matrix |
| Grinding wheel | WC in metal (Co) |
| Cutting tool | WC in metal (Co) |
| Boat Hulls | SiC or SiO₂ in polymer |
| Naval structures and Marine | TiO2 in PuF& TiO2 infused PuF |
| Boats | Al2O3 in polymer |
| Wind Power turbine blades | Al2O3 in polymer |
| Composites for construction | Al2O3 in polymer |
| Construction Building sections | CaCO3 in Eco flex |
| Construction structural panels | CaCO3 in Eco flex |
| Supeheater/reheater tubes | Al2O3 in a stainless steel |
| Low pressure turbine blading steam rotation | Al2O3 in a stainless steel |
| Condensers | Al2O3 in a stainless steel |
| Petroleum refinery equipment | Al2O3 in feritic and austenitic stainless steel |
| Plates, casting, forgings in refinery | Al2O3 in feritic and austenitic stainless steel |

The structural three dimensional nanocomposite are suitable for manufacturing the products at 25% of higher temperature of performance than the temperature of the metal matrix. A lifecycle cost of the structural three dimensional nanocomposites is lower than other nanocomposites. The structural three dimensional nanocomposite is having high fatigue property, high toughness, high impact performance, better wear property, scratch resistant, abrasion resistant, flame retardant and solvent resistant. Based on high specific strength and modulus, the structural three dimensional composite is light weighted material. The structural three dimensional nanocomposite is transparent to light in addition to the mechanical properties. The structural three dimensional nanocomposite is not oriented the processing of the spherical shaped nanoparticles reinforcement when compared to other nanocomposites.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A structural three dimensional nanocomposite composition with improved mechanical properties, comprising:
spherical shaped nanoparticles;
a matrix, wherein said spherical shaped nanoparticles are reinforced with said matrix, wherein said spherical shaped nanoparticles is uniformly distributed throughout said matrix; and
an inter phase structure that transfers stress from said matrix to said spherical shaped nanoparticles to obtain said structural three dimensional nanocomposite composition.

2. The structural three dimensional nanocomposite composition of claim 1, wherein said matrix is selected from at least one of (a) a nano metal matrix, and (b) a polymer matrix.

3. The structural three dimensional nanocomposite composition of claim 2, wherein said nano metal matrix is an aluminum, a magnesium, a stainless steel, and a titanium.

4. The structural three dimensional nanocomposite composition of claim 2, wherein said polymer matrix is a poly vinyl alcohol, a poly vinyl chloride, and a polystyrene.

5. The structural three dimensional nanocomposite composition of claim 1, wherein said spherical shaped nanoparticles are added with nano clay particles to decrease permeability of gases in packaging polymer applications.

6. A process of preparation of a structural three dimensional nanocomposite with improved mechanical properties, comprising:
providing spherical shaped nanoparticles;
providing a matrix, wherein said matrix is a polymer matrix;
providing an inter phase structure that transfers stress from said polymer matrix to said spherical shaped nanoparticles; and
reinforcing said spherical shaped nanoparticles with said polymer matrix to obtain said structural three dimensional nanocomposite,
wherein said spherical shaped nanoparticles are uniformly distributed throughout said polymer matrix.

7. The process of claim 6, wherein said matrix is a nano metal matrix.

8. The process of claim 7, wherein said nano metal matrix is an aluminum, a magnesium, a stainless steel, and a titanium.

9. The process of claim 6, wherein said polymer matrix is a poly vinyl alcohol, a poly vinyl chloride, and a polystyrene.

10. The process of claim 6, wherein said spherical shaped nanoparticles are added with nano clay particles to decrease permeability of gases in packaging polymer applications.

11. A structural three dimensional nanocomposite with improved mechanical properties, wherein said structural three dimensional nanocomposite comprises high and equal mechanical strength in said three dimensions when said structural three dimensional nanocomposite is at least one of (a) volume compressive stress condition, and (b) volume expansive stress condition, comprising:
spherical shaped nanoparticles;
a matrix, wherein said matrix is selected from at least one of (a) a polymer matrix and (b) a nano metal matrix, wherein said spherical shaped nanoparticles are reinforced with said matrix, wherein said spherical shaped nanoparticles are uniformly distributed throughout said matrix; and
an inter phase structure that transfers stress from said matrix to said spherical shaped nanoparticles.

12. The structural three dimensional nanocomposite of claim 11, wherein said mechanical properties comprise at least one of (a) measurement of elasticity, (b) tensile strength, (c) fracture toughness, and (d) fracture energy.

13. The structural three dimensional nanocomposite of claim 11, wherein said mechanical strength of said structural three dimensional nanocomposite is high when 5% of said spherical shaped nanoparticles are added with said matrix.

14. The structural three dimensional nanocomposite of claim 11, wherein said structural three dimensional nanocomposite is light weight material due to improved strength and modulus.

15. The structural three dimensional nanocomposite of claim 11, wherein said structural three dimensional nanocomposite is suitable for applications at a higher temperature.

16. The structural three dimensional nanocomposite of claim 11, wherein said mechanical properties are determined based on at least one of (a) a size of spherical shaped nanoparticles reinforcement, (b) a size of said inter phase structure, (c) a strength of said spherical shaped nanoparticles, and (d) a strength of said inter phase structure.

17. The structural three dimensional nanocomposite of claim 11, wherein said mechanical strength is increased when mechanical strength of said matrix is increased.

18. The structural three dimensional nanocomposite of claim 11, wherein said structural three dimensional nanocomposite is suitable for aerospace products and sport products due to less complexity and better affordability.

19. The structural three dimensional nanocomposite of claim 11, wherein said structural three dimensional nanocomposite is transparent to light due to said high mechanical properties.
